(19) United States
(12) Patent Application Publication
(10) Pub. No.: US 2005/0148696 A1
(43) Pub. Date: Jul. 7, 2005

(54) High thermal conductive halogen-free phosphorus-free retardant resin composition for printed circuit board materials

(75) Inventors: Ming-Cheng Hsiao, Taoyuan Hsien (TW); Tai-Wen Chien, Taoyuan Hsien (TW); Chang-Yung Wang, Taoyuan Hsien (TW)

Correspondence Address: TROXELL LAW OFFICE PLLC, SUITE 1404, 5205 LEESBURG PIKE, FALLS CHURCH, VA, 22041, US

(73) Assignee: Uniplus Electronics Co., Ltd.

(21) Appl. No.: 10/748,262

(22) Filed: Dec. 31, 2003

(51) Int. Cl. C08L 63/00

(52) U.S. Cl. 523/457

(57) ABSTRACT

A high thermal conductive halogen-free phosphorus-free retardant resin composition for printed circuit board materials is composed of (1) an epoxy resin having bifunctional or polyfunctional groups, in an amount of 10 to 50% by weight based on the total composition; (2) a retardant, having amide, imide and hydroxy functional groups, in an amount of 10 to 30% by weight based on the total composition; (3) an inorganic salts, in an amount of 10 to 50% by weight based on the total composition; and (4) a high thermal conductive metal powder, in an amount of 10 to 30% by weight based on the total composition. The present invention is free from phosphorus-containing retardant, and hence does not pollute the environment due to hydrolysis and further exhibits a characteristic of high thermal conductive that makes the operation of the electronic devices more stable.

### BACKGROUND OF THE INVENTION

1. Field of the Invention

The invention relates to a retardant resin composition for printed circuit board materials, and particularly to a high thermal conductive halogen-free and phosphorus-free retardant resin composition that characterizes in not incurring environmental pollution problem by undue combustion or hydrolysis and in its high thermal conductive property providing electronic devices with well heat dissipation capability, stable operation. The present invention is applicable to printed circuit board materials in a copper-clad substrate, a resin coated copper laminate and a multi-layer laminate.

2. Description of the Prior Art

As required by mass production of electronic and communication products and for meeting the trend of light and compact multifunctional design of electronic products, the technical level of the printed circuit board (PCB) as the main support for electronic parts is consistently promoted for providing high density wiring, thin configuration, microporosity, high dimensional stability, high heat dissipation ability and low cost. Particularly, the manufacturing and build-up technology of high density semiconductor assembly and the technical development for building-up organic materials having high heat dissipation ability constitute very important aspects of the current semiconductor assembly technologies.

Since certain studies had found that halogen-containing epoxy resin functioned as a retardant might produce hazardous carcinogenic gases such as poisonous dioxin and furane under improper combustion temperature (<1,000° C.). As the environmental sense raised recently, in addition to the relatively stringent requirement on the fire-proof safety, environmental protection has been concerned considerably. Under the presupposition of global consideration on the safety of fire-retardation, demand on environment-friendly material, commercial strategy and the like, the development on the new generation of environmental halogen-free printed circuit board, i.e., the so-called halogen-free material, has been positively undergone worldwide. At present, halogen-free materials for printed circuit board achieve their retardant function primarily by replacing brominated epoxy resin with phosphorus-based retardant. Although phosphorus-based retardant technology can replace effectively conventional halogen retardant, another environmental issue as eutrophication of rivers or lakes may be raised due to the hydrolysis of the phosphorus-based retardant. Furthermore, the high hydrolytic characteristics of the phosphorus-based retardant may degrade or destroy the long-term reliability of electronic products. The halogen-free phosphorus-free material system having retardant characteristics is expected to be the main stream in the market by replacing the current phosphorus-based retardant material system.

Among patents on halogen-free phosphorus-free retardant resins, JP Unexamined Publication No.11-35795 “Epoxy Resin Composition, Epoxy Resin Prepreg And Epoxy Resin Laminate” disclosed the fabrication of halogen-free phosphorus-free copper foil substrate by employing epoxy resin as the main component in combination with a melamine cyanurate retardant (MC-610). However, this product has following disadvantages: the price of the retardant used is too high and hence results in high cost of the product, and further the product did not exhibit a high thermal conductive characteristic. A U.S. Pat. No. 6,187,416, “Resin Composition for Copper-Clad Laminate, Resin-Coated Copper Foil, Laminate and Multiplayer Printed Circuit Board” disclosed a halogen-free phosphorus-free resin composition by using the combination of an epoxy resin with a retardant Bis(3-ethyl-5-methyl-maleimidophenyl) Methane Polyethersulfone (BMP). This composition is applicable to copper-clad laminate and resin coated copper foil laminate. However, it has following disadvantage: BMP compound belongs to a high performance and high price formulated resin and hence will result in an increase of the production cost and does not exhibit a high thermal conductive characteristic. Moreover, the patent has not disclosed as whether this material had a flammability rating of UL94-V0.

In view of the forgoing, regarding the development of retardant resin materials, directions can be made of follow aspects: improving the heat dissipation ability of the material to meet the trend of light weight and compact electronic products, the high speed requirement of photo-electronic communication products, the high integration requirement of micro-system products and the like. Furthermore, retardants of lower price and better effect can be selected and used to formulate halogen-free phosphorus-free retardant resins acceptable by environmental protection standards.

### SUMMARY OF THE INVENTION

The main object of the present invention is to provide a novel high thermal conductive, halogen-free and phosphorus-free retardant resin composition that characterizes in exhibiting advantages of a high heat dissipating capability and no pollution to the environment, and is applicable to a printed circuit board material.

Another object of the invention is to provide a high thermal conductive retardant resin composition characterized to lower the production cost and to increase the industry competition.

### BRIEF DESCRIPTION OF THE DRAWINGS

The drawings disclose an illustrative embodiment of the present invention which serves to exemplify the various advantages and objects hereof, and are as follows:

FIG. 1 is a flow chart showing the synthesis of high thermal conductive halogen-free and phosphorus-free retardant resin composition according to the present invention; and

FIG. 2 is a table showing formulation components and substrate materials of examples and comparative example of the high thermal conductive halogen-free and phosphorus-free retardant resin composition according to the present invention.

### DETAILED DESCRIPTION OF THE PREFERRED EMBODIMENT

The present composition that achieves the above-described objects comprises:
(1) an epoxy resin, having bifunctional and polyfunctional groups and an epoxide equivalent of 150 to 1000, in an amount of 10 to 50% by weight of the total composition, and, depending on various application functions of the composition, being selected from the group consisting of:
   (a) Resins of diglycidyl ether type;
   (b) Resins of cresol novolac type;
   (c) Bisphenol A type resin (BPA) for improving the flow property of the resin;
   (d) Styrene-maleic-anhydride resin (SMA) exhibiting high reliability and low hygroscopicity and heat resistance; and
   (e) Functional resin of poly-phenylene ether (PPE) capable of providing low dielectric constant;
(2) a retardant, having functional structure of amide, imide and hydroxy groups, in an amount of 10 to 30% by weight of the total composition, and having a chemical structure as (A): 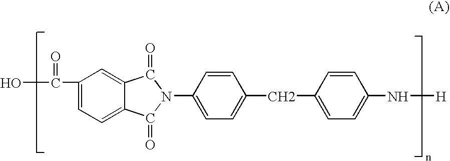
   wherein n is a positive integer;
(3) an inorganic salt, selecting from the group consisting of SiO₂, TiO₂, Al₂O₃, Al(OH)₃, Mg(OH)₂, CaCO₃, and mixture thereof, having an average particle size between 0.01 micron and 5 micron, and in an amount of 10 to 50% by weight of the total composition; and
(4) a high thermal conductive metal powder, selecting from the group consisting of aluminum nitride (AlN), boron nitride (BN), aluminum oxide (Al₂O₃), silver (Ag), aluminum (Al), zinc oxide (ZnO), Carbon Nano Tube (CNT) and mixture thereof, wherein its average particle size is between 0.01 micron and 10 micron, and in an amount of 10 to 30% by weight of the total composition.

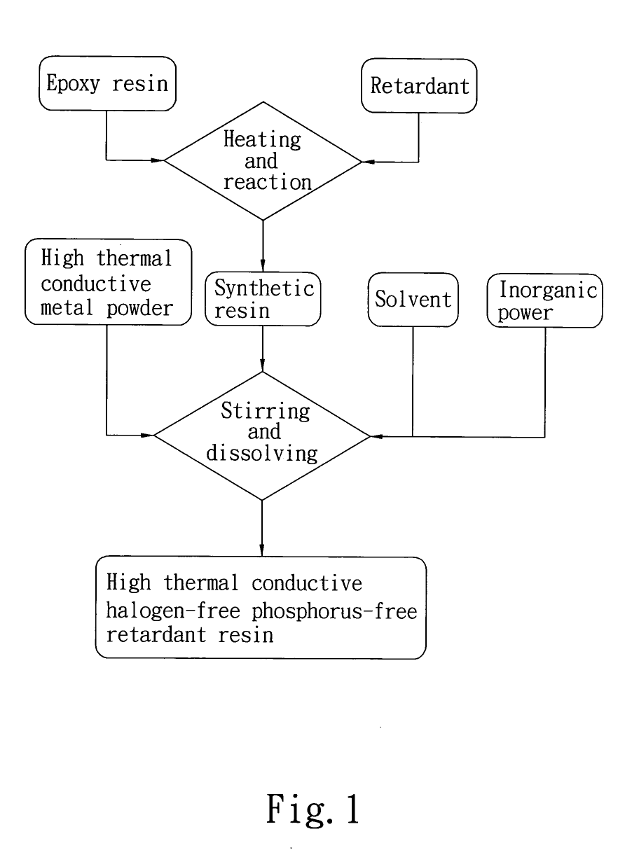

The synthetic method of the present invention comprises primarily of mixing and reacting under stirring an epoxy resin having amide, imide and hydroxy groups with a retardant having high nitrogen content, and controlling the temperature to undergo pre-polymerization to form a synthetic resin. Then, the inorganic powder, the high thermal conductive metal powder and the solvent are added and mixed homogeneously under stirring to form the high thermal conductive, halogen- and phosphorus-free retardant resin. FIG. 1 shows a flow chart for its synthetic protocol.

For the present invention to be better understood, it will be described further in detailed with reference to the following examples.

### EXAMPLE 1

In a 2-liter, 4-necked glass reactor equipped with a 3-blade stirrer, 530 g of an epoxy resin of cresol novolac type (ECN-1299, CIBA CHEMICAL Co.), 453.2 g of a polyimide retardant (AI-32T, FU-PAO CHEMICAL Co.) and 245.8 g of N,N′-dimethyl-formamide (DMF) as the solvent are added and heated under stirring to 120° C. for 3 hours. After cooling to room temperature, 912.3 g of diglycidyl ether of bisphenol A epoxy resin (DGEBA, EPON-828, SHELL CHEMICAL Co.), 369.7 g of 4,4′-Diamino Diphenyl Sulphone (4,4′-DDS) as the hardener, 1372 g of Al(OH)₃, 484.2 g of Al₂O₃ and 645.6 g of DMF as the solvent are added further and stirred homogeneously to yield a novel high thermal conductive, halogen-free, phosphorus-free retardant resin formulation.

### EXAMPLE 2

In a 2-liter, 4-necked glass reactor equipped with a 3-blade stirrer, 530 g of an epoxy resin of cresol novolac type (ECN-1299, CIBA CHEMICAL Co.), 453.2 g of a polyimide retardant (AI-32T, FU-PAO CHEMICAL Co.) and 245.8 g of DMF as the solvent are added and heated under stirring to 120° C. for 3 hours. After cooling to room temperature, 912.3 g of diglycidyl ether of bisphenol A epoxy resin (DGEBA, EPON-828, SHELL CHEMICAL Co.), 369.7 g of 4,4′-DDS as the hardener, 1856.2 g of Al(OH)₃ and 645.6 g of DMF as the solvent were added further and stirred homogeneously to yield a novel halogen-free, phosphorus-free retardant resin formulation.

For comparing the retardant properties of these examples, a synthesis as a comparative example is carried out separately.

### COMPARATIVE EXAMPLE

In a 2-liter, 4-necked glass reactor equipped with a 3-blade stirrer, 530 g of an epoxy resin of cresol novolac type (ECN-1299, CIBA CHEMICAL Co.), 453.2 g of a polyimide retardant (AI-32T, FU-PAO CHEMICAL Co.) and 245.8 g of N,N′-dimethyl-formamide (DMF) as the solvent are added and heated under stirring to 120° C. for 3 hours. After cooling to room temperature, 912.3 g of diglycidyl ether of bisphenol A epoxy resin (DGEBA, EPON-828, SHELL CHEMICAL Co.), 369.7 g of 4,4′-DDS as the hardener, and 645.6 g of DMF as the solvent are added further and stirred homogeneously to yield a halogen-free phosphorus-free resin formulation.

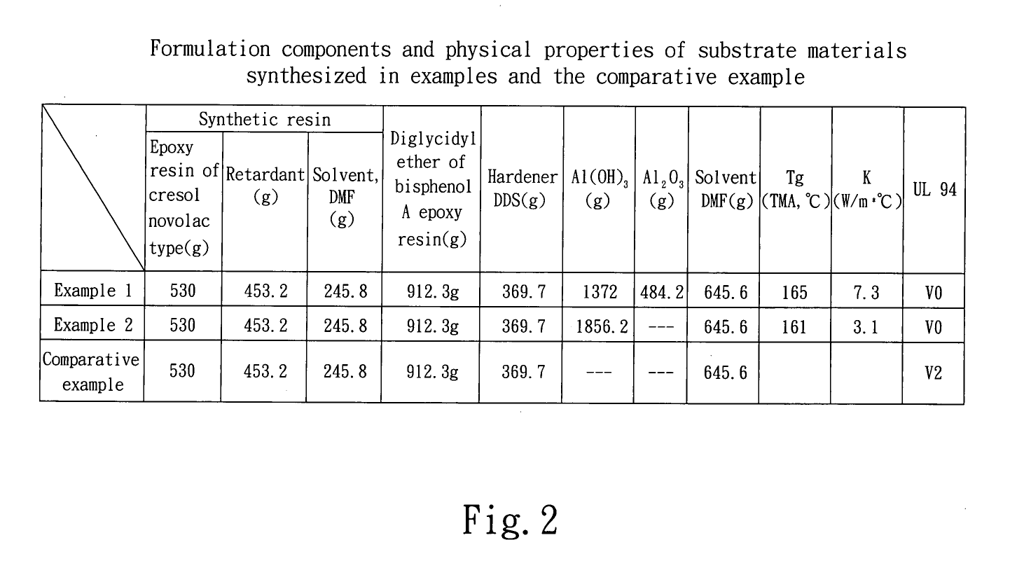

FIG. 2 lists physical properties of two examples and the comparative example described above. It can be observed from this table that these two examples exhibited good glass transition temperature (Tg) and coefficient of thermal conductivity (K). With respect to the flame resistant, the flammability rating of two examples were UL94-V0, considerably better than that of the comparative example (UL94-V2). These results demonstrate that examples formulated according to the concept of the present invention have indeed better thermal conductive effect and retardant property.

Therefore, the invention has the following advantages:
1. The halogen-free and phosphorus-free retardant resin composition according to the present invention has not a property of high hygroscopicity and hydrolysis and causes no environmental problem. As a result, it can increase the use reliability of electronic products.
2. The halogen-free and phosphorus-free retardant resin composition according to the present invention has a high coefficient of thermal conductivity and a good flammability rating. When used as the material of a printed circuit board, it can provide a working environment for the stable operation and good heat dissipation of electronic products.
3. Materials used in the halogen-free and phosphorus-free retardant resin composition according to the present invention have low prices so that it can be used as a basic material with industry competitive advantage.
4. The halogen-free and phosphorus-free retardant resin composition according to the present invention exhibits a high compatibility with the current conventional process for fabricating a printed circuit board so that it can substitute directly for the current printed circuit board material without significant change on process and equipments. Hence it allows an extremely wide industrial application.

Accordingly, the invention described above can achieve objects expected, and provides a high thermal conductive halogen-free and phosphorus-free retardant resin composition that has low price, good heat dissipation effect and good industrial application.

Therefore, many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

1. A high thermal conductive halogen-free phosphorus-free retardant resin composition comprising:
(1) an epoxy resin, having bifunctional and polyfunctional groups, in an amount of 10 to 50% by weight of the total composition;
(2) a retardant, having functional structure of amide, imide and hydroxy groups, in an amount of 10 to 30% by weight of the total composition, and having a chemical structure as (A): 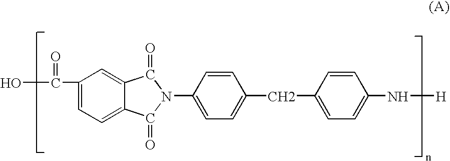
wherein n is a positive integer;
(3) an inorganic salt, in an amount of 10 to 50% by weight of the total composition; and
(4) a high thermal conductive metal powder, in an amount of 10 to 30% by weight of the total composition.

2. The high thermal conductive halogen-free phosphorus-free retardant resin composition as claimed in claim 1, wherein said epoxy resin has an epoxide equivalent of 150 to 1000.

3. The high thermal conductive halogen-free phosphorus-free retardant resin composition as claimed in claim 1, wherein said epoxy resin is selected depending on the application function from the group consisting of resins of diglycidyl ether type, resins of cresol novolac type, bisphenol A type resin (BPA) for improving the flow property of the resin, styrene-maleic-anhydride resin (SMA) exhibiting high reliability and low hygroscopicity and heat resistance, and functional resin of poly-phenylene ether (PPE) capable of providing low dielectric constant.

4. The high thermal conductive halogen-free phosphorus-free retardant resin composition as claimed in claim 1, wherein said inorganic powder is selected from the group consisting of silicon dioxide, titanium dioxide, alumina, aluminum hydroxide, magnesium hydroxide, calcium carbonate and mixtures thereof having an average particle size between 0.01 micron and 5 micron.

5. The high thermal conductive halogen-free phosphorus-free retardant resin composition as claimed in claim 1, wherein said high thermal conductive powder is selected from the group consisting of aluminum nitride, boron nitride, aluminum oxide, silver, aluminum, zinc oxide, carbon nano tube (CNT) and mixture thereof having a average particle size is between 0.01 micron and 10 micron.
